(19) United States
(12) Patent Application Publication
(10) Pub. No.: US 2002/0116606 A1
(43) Pub. Date: Aug. 22, 2002

(54) Encryption and decryption system for multiple node network

(76) Inventor: Stephan W. Gehring, Menlo Park, CA (US)

Correspondence Address: Kenneth D'Alessandro, Sierra Patent Group, P.O. Box 6149, Stateline, NV, 89449, US

(21) Appl. No.: 09/788,295

(22) Filed: Feb. 16, 2001

(51) Int. Cl. H04L 9/00

(52) U.S. Cl. 713/153

(57) ABSTRACT

An encryption and decryption system and method for message forwarding in a multi-node network which provides fast message forwarding while minimizing CPU time and power requirements by unconditional decryption of all incoming messages and unconditional encryption or re-encryption of all outgoing messages, which pass through a forwarding node or nodes. Messages from a source node to the destination node pass through the forwarding node, which unconditionally decrypts the incoming message from the source node without prior determination of the ultimate destination of the message. The forwarding node then unconditionally re-encrypts the outgoing or forwarded message for transmission to the destination node.

### BACKGROUND OF THE INVENTION

1. Field of the Invention

This invention pertains generally to methods for message encryption in multiple node networks. More particularly, the invention is an encryption and decryption system for multi-node networks which provides fast message forwarding decisions using simple hardware and software, wherein a forwarding node unconditionally decrypts all incoming messages, and then re-encrypts and forwards messages destined for other nodes.

2. Description of the Background Art

Network systems for data communication exchange have been evolving for the past several decades. Particularly, computer network systems have been developed to exchange information and provide resource sharing. Network systems generally comprise one or more nodes which are interconnected and capable of communicating. The most common network systems today are “wired” local area networks and wide area networks. Normally, nodes participating in such wired networks are physically connected to each other by a variety of transmission medium cabling schemes including twisted pair, coaxial cable, fiber optics and telephone systems including time division switches, integrated services digital network, and asymmetric digital subscriber line. In order to overcome the drawbacks associated with physical cabling, wireless data communication networks are increasingly used.

In networks consisting of multiple interconnected nodes, certain nodes may act as relays that forward messages between nodes which cannot communicate directly, as is frequently the case in wireless networks. In wireless networks, the use of forwarding nodes is often an important consideration because the distance between and/or physical location of sending and receiving nodes may preclude direct communication. Typically, messages delivered along a multi-node network are encrypted to protect potentially confidential information from eavesdroppers, including forwarding or intermediate nodes which are not the intended destination of a message.

FIG. 1 shows a forwarding node message routing architecture 10 as used in prior art systems for conditional decryption and encryption of forwarded messages. The architecture 10 includes a node processor or CPU 12, a primary buffer 14, a secondary buffer 16, a decryption engine 18 and an encryption engine 19. Upon receiving a message, a forwarding node must make a decision as to whether the received message is to be consumed internally or forwarded to another destination. In prior art systems, when a forwarding node receives an encrypted message via the network, the node processor 12 must make a decision as to whether the message is for itself or if the message is to be forwarded to another node. If the incoming message is intended for internal consumption, the message is routed to the decryption engine 18, which uses a decryption key to decrypt the message. If the incoming message is to be forwarded to another destination, decryption engine 18 is bypassed and the message is streamed into the primary message buffer 14 to await forwarding to a different node. In the case of outgoing messages, the node processor 12 again must make a decision as to whether the outgoing message must be encrypted via encryption engine 19 according to a particular destination address, or if encryption is unnecessary.

The above arrangement results in some important drawbacks. The decision by processor 12 whether to retain or forward a message involves substantial computational overhead, with address table lookups used to determine message destination. Thus, an additional, secondary message buffer 16 is usually employed to hold incoming message data while a decision is made by processor 12 regarding the destination of the message. Further, the need to “tag” or otherwise attribute information to outgoing messages as to whether or not encryption is required involves still more computational overhead. The need to buffer messages on the input side with a separate, secondary buffer 16, and the decision making as to whether or not to decrypt incoming messages and encrypt outgoing messages, increases the complexity of the hardware and software architectures associated with the forwarding node's transmitter and receiver operations, and generally slows down the message forwarding process across the network.

There is accordingly a need for an encryption and decryption system for multi-node networks which allows rapid forwarding of messages to destination nodes, which avoids delays associated with encryption and decryption decisions, and which does not require a secondary message buffer for storage of incoming messages while decryption decisions are made. The present invention satisfies these needs, as well as others, and generally overcomes the deficiencies found in the background art.

### SUMMARY OF THE INVENTION

The invention is an encryption and decryption system and method for a multi-node network which provides fast message forwarding while minimizing CPU time and power requirements for forwarding nodes. In its most general terms, the invention is a method for forwarding encrypted messages in a multi-node network which comprises unconditional decrypting, by each node, of all incoming messages and, preferably, unconditional encrypting all outgoing messages by the nodes. The invention is also a method for encryption and decryption of messages in a multi-node network which comprises decrypting all incoming messages by each node before any decision is made by the node regarding message destination.

By way of example, and not necessarily of limitation, the network system of the invention will generally include a source node, a destination node, and at least one forwarding node. Messages from the source node to the destination node pass through the forwarding node, which unconditionally decrypts the incoming message from the source node, and then unconditionally re-encrypts the outgoing or forwarded message to the destination node.

In the forwarding of messages between nodes generally, the invention utilizes an encryption algorithm E with a key K_{E} to encrypt plaintext messages P into ciphertext C, and a decryption algorithm D with a key K_{D} to decrypt ciphertext C into plaintext P. Thus, the encrypted ciphertext C can be represented by C=E(P, K_{E}), and the recovered plaintext P after decryption can be represented as P=D(C, K_{D}). In the encryption and decryption system provided by the invention, the relationship

P=D(E(P, K_{E}), K_{D})=E(D(P, K_{D}), K_{E})

is maintained or otherwise holds true. In some preferred embodiment of the invention, each node in the network system uses symmetric encryption and decryption, i.e., the same key is used for encryption and decryption. Where the encryption and decryption algorithms are symmetrical, K_{D} and K_{E} are the same (K_{E}=K_{D}). In embodiments using asymmetric encryption and decryption, K_{E}≠K_{D}.

In order to share and understand secure messages, the source node will use an encryption key K_{E1} and the intended destination node in a network will use a decryption key K_{D1}, which are used respectively for encryption and decryption of messages. The forwarding node, however, will have its own keys K_{E2}, K_{D2} for encryption and decryption which are generally different from the keys K_{E1}, K_{D1} used by the source and destination nodes. The different keys K_{E2}, K_{D2} allow the forwarding node to unconditionally decrypt and encrypt forwarded messages, but prevent the forwarding node from unauthorized access to the information or data contained in a forwarded message. In some embodiments of the invention, keys K_{E1}, K_{D1} may be the same as keys K_{E2}, K_{D2} respectively.

In operation, the source node encrypts a plaintext message P₁ using encryption algorithm E and key K_{E1} to create a ciphertext message C₁ via C₁=E(P₁, K_{E1}), and transmits the ciphertext message C₁ to the forwarding node. The forwarding node receives and unconditionally decrypts the ciphertext message C₁ using decryption algorithm D with key K_{D2} to produce a plaintext message P₂ which can be expressed as the relationship:

P₂=D(C₁, K_{D2})=D(E(P₁, K_{E1}), K_{D2}).

The forwarding node then re-encrypts the plaintext P₂ using encryption algorithm E and key K_{E2} to form ciphertext C₂=E(P₂, K_{E2}), which results in the creation of the original ciphertext message C₁ via the relationship:

C₂ E(P₂, K_{E2})=E(D(C₁K_{D2}), K_{E2})=C₁

The ciphertext C₁ is then transmitted by the forwarding node to the destination node, which receives and then decrypts the ciphertext message C₁ using decryption algorithm D and key K_{D1} to recover the original plaintext message P₁ as the relationship:

P₁=D(C₁, K_{D1})

The above encryption and decryption procedure allows the forwarding node to unconditionally decrypt the ciphertext using its own key with a decryption algorithm and buffer the deciphered text until it is ready to transmit to the destination node. Since the forwarding node does not have the correct key for the ciphertext, i.e., key K_{D2} is not the correct key for ciphertext C₁, the buffered text message P₂ is unintelligible to the forwarding node. The forwarding node then unconditionally encrypts the deciphered text P₂, again using its own key K_{E2}, to reproduce the ciphertext message C₁ for transmission to the destination node, where the ciphertext C₁ is decrypted again, this time using the correct key K_{D1} to recover the original plaintext message P₁.

The encryption and decryption as described above is shown as entirely asymmetric, with K_{E1}≠K_{D1} and K_{E2}≠K_{D2}. The encryption and decryption procedure of the invention as related above may be entirely symmetric wherein K_{E1}=K_{D1}=K₁, and K_{E2}=K_{D2}=K₂. In the symmetrical case, the plaintext message as ultimately recovered by the destination node can be represented more simply as

P₁=D(E(D(E(P₁, K₁), K₂), K₂), K₁)

The unconditional decryption of all forwarded messages by the forwarding node in the above manner removes the time consuming decision process regarding whether or not an incoming message should be encrypted or decrypted according to a particular destination address, and eliminates the need for a secondary or input buffer for storage of un-decrypted messages during that decision process. The unconditional re-encryption avoids the need to attribute outgoing messages from the forwarding node with information, for the transmitter hardware, as to whether or not the outgoing message is to be encrypted or not. The use of a different key by the forwarding node also allows the forwarding node to act as a message destination without unauthorized eavesdropping by other nodes.

### BRIEF DESCRIPTION OF THE DRAWINGS

The present invention will be more fully understood by reference to the following drawings, which are for illustrative purposes only.

FIG. 1 is a functional block diagram of a prior art message forwarding hardware architecture for a node.

FIG. 2 is a schematic diagram of a multi-node wireless network showing a source node, three forwarding nodes, and a destination node.

FIG. 3 is a schematic diagram illustrating the encryption and decryption system of the invention.

FIG. 4 is a functional block diagram illustrating generally the hardware embodying the encryption and decryption system of the invention as implemented in a forwarding node.

FIG. 5 is a flow chart illustrating generally the encryption and decryption method of the invention using symmetric encryption and decryption.

### DETAILED DESCRIPTION OF THE PREFERRED EMBODIMENTS

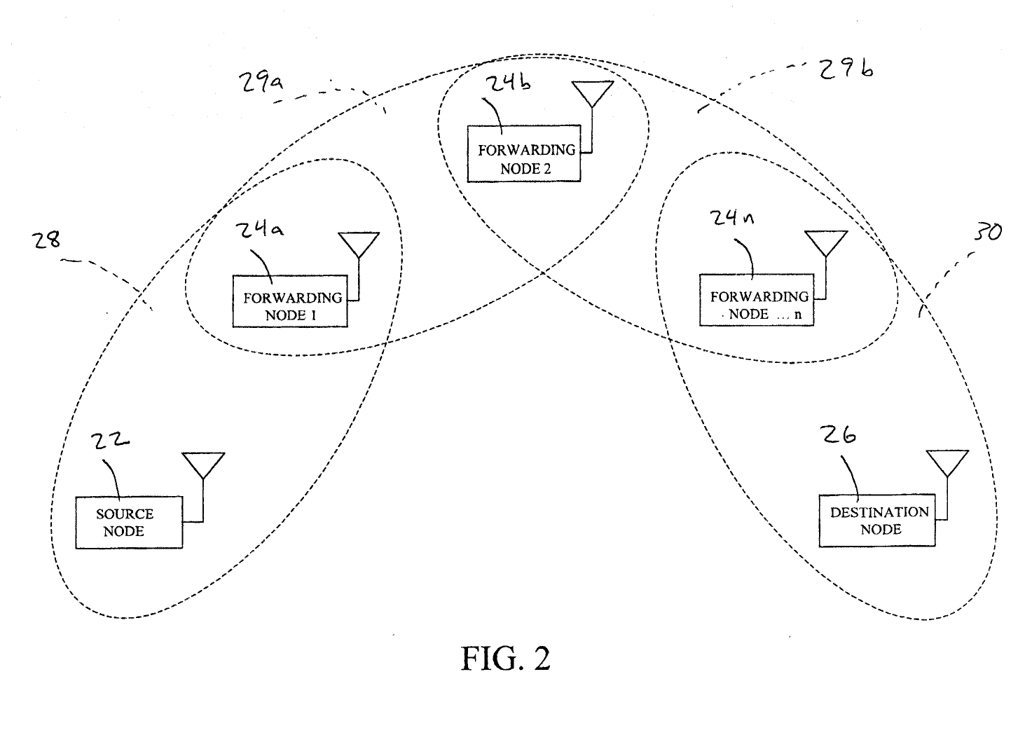

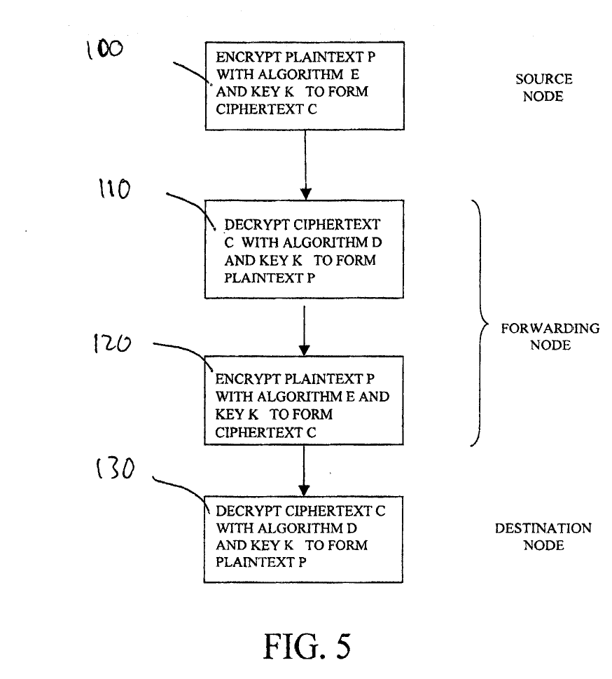

Referring more specifically to the drawings, for illustrative purposes the present invention is embodied in the system shown generally in FIG. 2 through FIG. 4, and the method shown generally in FIG. 5. It will be appreciated that the system may vary as to configuration and as to details of the parts, and that the method may vary as to details and the order of the steps, without departing from the basic concepts as disclosed herein. The invention is disclosed generally in terms of use in a wireless network of multiple transceiver devices. However, it will be readily apparent to those skilled in the art that the invention may be used in numerous types of data transmission and reception applications, including wired and fiberoptic communication networks, and the details and To specificities discloses herein are only exemplary and should not be considered limiting. It will also be appreciated by-those skilled in the art that various functional components of the invention as described herein may in many instances share logic and be implemented within the same circuit or in different circuit configurations.

Referring first to FIG. 2, the invention is generally embodied in a wireless network 20 comprising a plurality of transceiver devices or nodes, which are shown as a source node 22, forwarding nodes 24a, 24b . . . 24n, and a destination node 26. The transmitter and receiver architectures of transceiver nodes 22, 24, 26 can be configured in a variety of ways which are well known in the art. Data is transmitted between the transceiver nodes 22, 24, 26 of network 20 preferably in the form of packets or frames. Frames generally contain the data to be transmitted as well as information regarding the source and destination nodes.

In the network 20 of FIG. 2, transceiver nodes 24a, b, . . . n are shown positioned in between source node 22 and destination node 26 to act as a forwarding or relaying nodes. There may be any number of intervening for forwarding nodes 24a-n, although only three are shown in FIG. 2 for reason of clarity. As can frequently occur in wireless networks, source node 22 and destination node 26 may not be within suitable range of each other for direct data transmission, because of distance, an intervening obstacle (not shown) which blocks or otherwise prevents effective direct communication, or other reason. Source node 22 and forwarding node 24a are shown as having a shared region or range 28 in which effective data transmission is possible. Forwarding nodes 24a and 24b likewise have a shared range 29a, while forwarding nodes 24b and 24n have a shared range 29b. Forwarding node 24n and destination node 26 are shown with a shared region or range 30. The various overlapping portions of ranges 28, 29a, 29b and 30 allow messages to be forwarded from node 22 to node 26 via the intervening nodes 24a-n, and vice versa.

The network 20 will generally comprise additional transceiver nodes (not shown), with each node in the network comprising generally the same transmitter and receiver configuration as nodes 22-26. Thus, in network 20, multiple source nodes and multiple destination nodes may share a single common forwarding node in some instances, and multiple forwarding nodes may be required between a particular source and destination node. In some instances nodes 22 and 26 in network 20 may act as forwarding nodes for node 24a or 24n when these nodes are a message destination, or nodes 22, 26 may act as forwarding nodes for other nodes (not shown). The particular arrangement of the network 20 will generally vary according to its particular use, and the arrangement shown in FIG. 2 is only exemplary.

The transceiver nodes 22, 24a-n, 26 of network 20 advantageously use a message forwarding method wherein all incoming encrypted messages received by each forwarding node 24a-n are unconditionally decrypted, using the forwarding node's decryption key, prior to any decision making by the forwarding node 24a-n as to whether the incoming message is directed to itself or to a different destination. Preferably, all messages transmitted or forwarded by nodes 24a-n are unconditionally encrypted or re-encrypted, using the forwarding node's encryption key. This message forwarding method eliminates the need by the forwarding nodes 24a-n for hardware and software associated with decision making, based on destination address, regarding whether or not an incoming messages should be decrypted, and whether or not outgoing messages need to be encrypted.

Generally, in the forwarding of messages between nodes of a network, the invention utilizes an encryption algorithm E with a key K_{E} to encrypt plaintext messages P into ciphertext C, and a decryption algorithm D with a key K_{D} to decrypt ciphertext C into plaintext P. Thus, the encrypted ciphertext C can be represented by C=E(P, K_{E}), and the recovered plaintext P after decryption can be represented as P=D(C, K_{D}). The encryption and decryption algorithms used in the present invention will generally satisfy the following relationship:

P=D(E(P, K_{E}), K_{D})=E(D(P, K_{D}), K_{E})

This relationship is maintained or otherwise holds true during all encryption and decryption operations with the invention.

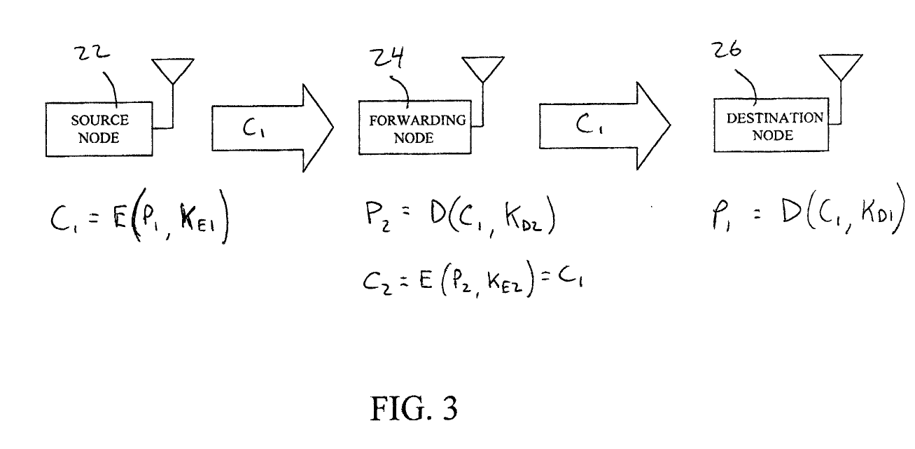

With the above relationship in mind, reference is now made to FIG. 3, wherein the operation of the message forwarding of the invention over multi-node network 20 is shown. In FIG. 3 only a single forwarding node 24 is shown for clarity, although a larger number of forwarding nodes may be present as noted above. The source node 22 has an encryption key K_{E1} used for encryption with algorithm E, while destination node 26 has a decryption key K_{D1} used for decryption with algorithm D. Forwarding node 24 generally has different keys K_{E2}, K_{D2} which are respectively used for encryption with algorithm E and decryption with algorithm D.

Initially, a plaintext message P₁ at source node 22 is encrypted to form a ciphertext message C₁, using encryption algorithm E and key K_{E1}, such that ciphertext C₁=E(P₁, K_{E1}), as shown in FIG. 3. Destination node 26 ultimately recovers and decrypts the plaintext message P₁ using decryption algorithm D and key K_{D1}, with recovered plaintext P₁=D(C₁, K_{D1}) as described further below. Prior to reaching destination node 26, ciphertext C₁ is transmitted to forwarding node 24 by source node 22.

Forwarding node 24 uses the same encryption and decryption algorithms D, E as source and destination nodes 22, 26, but with generally different encryption and decryption keys K_{E2}, K_{D2} (Keys K_{E1}, K_{D1} are not available to forwarding node 24), so that forwarding node 24 cannot eavesdrop on messages which it forwards between nodes 22, 26. The ciphertext C, transmitted by source node 22 is received by forwarding node 24 and decrypted by forwarding node 24 using decryption algorithm D and key K_{D2} to produce plaintext P₂. The plaintext P₂, as decrypted by the forwarding node 24 can be represented as:

P₂=D(C₁, K_{D2})=D(E(P₁, K_{E1}), K_{D2}).

Since decryption key K_{D2} is the incorrect key for ciphertext C₁, the decrypted plaintext P₂ is not intelligible to forwarding node 24, and the information contained therein is thus protected from unauthorized access or use by forwarding node 24.

Forwarding node 24 stores the decrypted plaintext message P₂ in a buffer until node 24 is ready to forward the message. The plaintext P₂ is then encrypted using encryption algorithm E and key K_{E2} to again produce ciphertext C₁. The ciphertext C₁ resulting from the encryption of plaintext P₂ by forwarding node can be shown as:

C₂=E(P₂, K_{E2})=E(D(C₁, K_{D2}), K_{E2})=C₁

The ciphertext message C₁ is then transmitted to destination node 26.

Destination node 26 receives the ciphertext C₁ transmitted from forwarding node 24, and ciphertext C₁ is decrypted using the correct key K_{D1} with decryption algorithm D to reproduce the original plaintext message P₁ as transmitted from source node 22. The original plaintext message P₁ as recovered by destination node 26, after forwarding, can be represented by:

P₁=D(C₁, K_{D1}).

The above message forwarding method allows forwarding node 24 to unconditionally decrypt the incoming ciphertext message C₁ from source node 22 without first having to determine if the message C₁ is intended for forwarding node 24 itself (i.e., forwarding node 24 is the final destination for the message) or if the message is for destination node 26. This allows the processor of forwarding node 24 to buffer the decrypted message and delay decision making about forwarding or retaining a message until a convenient time. The processor thus is not forced to react to an incoming message immediately when it is received.

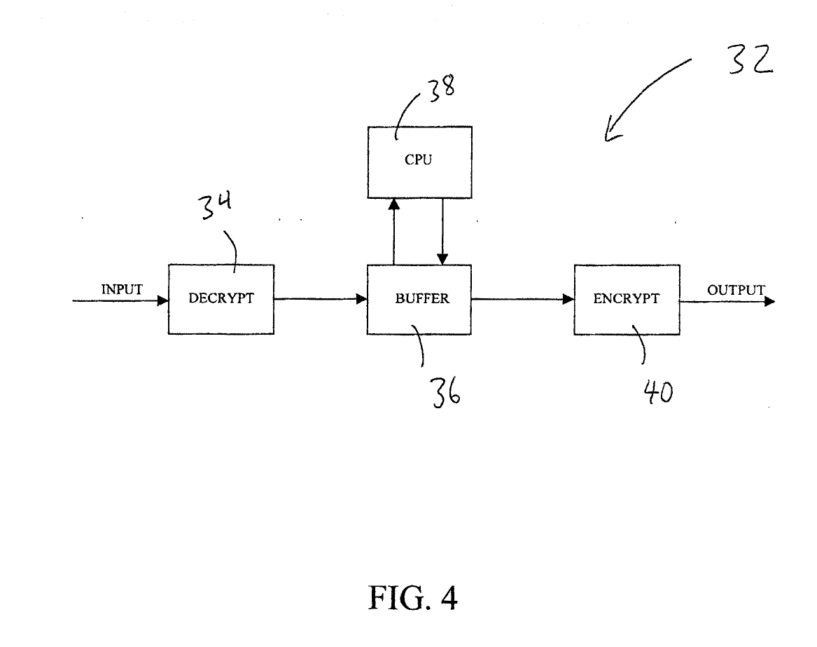

The unconditional decryption described above also allows relatively simple hardware and software architectures to be used for the message forwarding process of the invention. Referring to FIG. 4, there is shown an encryption and decryption system 32 in accordance with the invention as embodied in forwarding transceiver node 24. Encryption/decryption system 32 includes a decryption engine 34 which is operatively coupled to a memory buffer 36 and a receiver (not shown) associated with the transceiver node. Buffer 36 is operatively coupled to the node's central processing unit or CPU 38, and to an encryption engine 40. Encryption engine 40 is also operatively coupled to the node transmitter (not shown). CPU 38 may comprise any conventional data processor device, and buffer 36 may comprise any conventional RAM or like memory device. The nature of encryption and decryption engines of this sort is well known in the art and need not be described herein.

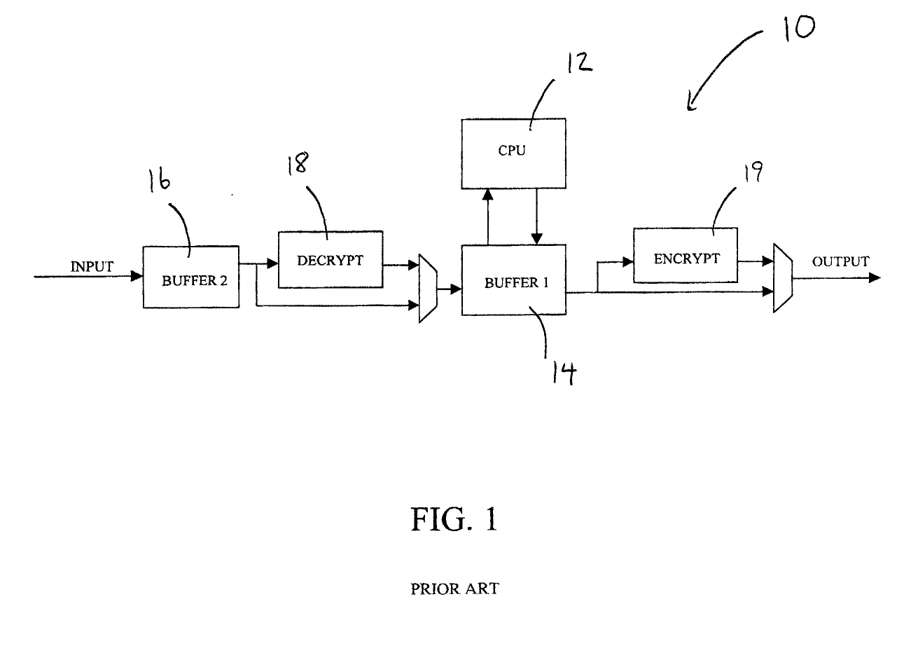

Notably, the encryption and decryption system 32 of FIG. 4 does not include a separate input buffer 16 for storage of messages prior to decryption, as used in prior art systems and shown in FIG. 1. All incoming messages are decrypted by engine 34 unconditionally prior to any decision-making as to message destination, and the decrypted message is directed to buffer 36 to await forwarding decisions by processor 38. The system 32 also does not require separate data input paths to buffer 36 for encrypted and un-encrypted messages, since all messages are unconditionally decrypted by engine 34. Further, CPU 38 is not required to make any encryption decisions regarding outgoing messages, as all outgoing messages are unconditionally encrypted (or re-encrypted) by engine 40. The encryption and decryption system 32 thus is relatively simple and inexpensive to implement, and allows faster forwarding of encrypted messages than has previously been available.

The invention also advantageously permits each transceiver node in a network to utilize the same encryption/decryption algorithm while preventing potential eavesdropping on a forwarded message, by use of different keys or ciphers where appropriate. Referring again to FIG. 2, it should be noted that node 24 may be a destination node as well as a forwarding node, with messages forwarded to node 24 by node 22 or 26. In such cases, the different keys K_{E2}, K_{D2} at node 24 prevents eavesdropping by nodes 22 or 26 on messages forwarded to node 24, in the same manner as described above.

Message forwarding encryption and decryption as shown in FIG. 3 and described above is asymmetric, with different, separate keys being used for encryption and decryption operations. It should be readily understood, however, that message forwarding in accordance with the invention may be carried out via symmetric encryption, wherein K_{E1}=K_{D1} and K_{E2}=K_{D2}.

The method of the invention as used with symmetric encryption and decryption will be more fully understood by reference to the flow chart of FIG. 5, as well as FIG. 2 and FIG. 3. In the events of FIG. 5, a single key K₁ is used by source node 22 and destination node 26 for both encryption and decryption, such that K_{E1}=K_{D1}=K₁, and a single (but generally different) key K₂ is used by forwarding node 24 for encryption and decryption, such that K_{E2}=K_{D2}=K₂. While in the following example the keys K₁, K₂, are different, it should be understood that in some embodiments of the invention these keys may be the same.

At event 100, a plaintext message P₁ at source node 22 is encrypted using encryption algorithm E and key K₁ to produce ciphertext message C₁. With symmetric encryption and decryption, ciphertext C₁ can be represented as C₁ E(P₁, K₁). Ciphertext C₁ is then transmitted to forwarding node 24.

At event 110, ciphertext message C₁ is received and decrypted by forwarding node 24 using decryption algorithm D and key K₂ to produce plaintext P₂ which, in this case may be shown as:

P₂D(C₁, K₂)=D(E(P₁, K₁), K₂).

Plaintext P₂ is created via unconditional decryption, so there is no need to independently buffer ciphertext message C₁ prior to decryption, as noted above. Also, since forwarding node 24 has the incorrect key (K₂ instead of the required K₁) for plaintext P₁, the decrypted message is not intelligible to forwarding node 24, and forwarding node 24 cannot make unauthorized use of data contained in plaintext message P₂.

At event 120, plaintext message P₂ is encrypted by forwarding node 24 using encryption algorithm E and key K₂ to again produce ciphertext C₁, which is transmitted to destination mode 26. The reproduced ciphertext in this instance can be shown by:

C₂=E(D(C₁, K₂), K₂)=C₁

At event 130, destination node 26 receives the ciphertext message C₁ transmitted by forwarding node 24 and applies encryption algorithm E with key K₁ to recover the original plaintext message P₁. According to the symmetrical encryption and decryption, the recovered plaintext P₁ by destination node 26 may be considered as

P₁=D(C₁, K₁)

Accordingly, it will be seen that this invention provides a message forwarding system for multi-node networks which allows fast message forwarding while minimizing CPU time and power requirements for forwarding nodes. Although the description above contains many specificities, these should not be construed as limiting the scope of the invention but as merely providing an illustration of the presently preferred embodiment of the invention. Thus the scope of this invention should be determined by the appended claims and their legal equivalents.

What is claimed is:

1. A method for forwarding messages in a multi-node network comprising unconditionally decrypting, by a forwarding node, each message received by said forwarding node.

2. The method of claim 1, further comprising unconditionally encrypting each message transmitted by said forwarding node.

3. The method of claim 2, wherein said unconditional decrypting and said unconditional encrypting are carried out using symmetrical encryption and decryption.

4. The method of claim 2, wherein said unconditional decrypting and said unconditional encrypting are carried out using asymmetric encryption and decryption.

5. A method for forwarding messages in a multi-node network comprising decrypting, by a forwarding node, each message received by said forwarding node prior to determining a destination for said received message.

6. The method of claim 5, further comprising encrypting, by said forwarding node, each message transmitted by said forwarding node.

7. The method of claim 6, wherein said decrypting and said encrypting are carried out using a symmetrical encryption and decryption algorithm.

8. The method of claim 6, wherein said decrypting and said encrypting are carried out using an asymmetric encryption and decryption algorithm.

9. A method for encrypting and decrypting messages in a multi-node network, comprising:
(a) encrypting a message by a source node and transmitting said encrypted message to a forwarding node;
(b) receiving and unconditionally decrypting said encrypted message by said forwarding node;
(c) unconditionally re-encrypting said decrypted message by said forwarding node and transmitting said re-encrypted message to a destination node; and
(d) receiving and decrypting said re-encrypted message by said destination node.

10. The method of claim 9, wherein said encrypting said message by said source node, said unconditional decrypting of said transmitted message by said forwarding node, said unconditional re-encrypting of said decrypted message by said forwarding node, and said decrypting of said re-encrypted message by said destination node, are carried out using symmetrical encryption and decryption.

11. The method of claim 10, wherein:
(a) said encrypting said message by said source node is carried out using a first key;
(b) said decrypting said re-encrypted message by said destination node is carried out using said first key;
(c) said unconditional decrypting of said transmitted message by said forwarding node is carried out using a second key; and
(d) said unconditional re-encrypting of said decrypted message by said forwarding node is carried out using said second key.

12. The method of claim 11, wherein said second key is different from said first key.

13. The method of claim 11, wherein said second key and said first key are the same.

14. The method of claim 9, wherein said encrypting said message by said source node, said unconditional decrypting of said transmitted message by said forwarding node, said unconditional re-encrypting of said decrypted message by said forwarding node, and said decrypting of said re-encrypted message by said destination node, are carried out using asymmetric encryption and decryption.

15. The method of claim 14, wherein:
(a) said encrypting said message by said source node is carried out using a first encryption key;
(b) said decrypting said re-encrypted message by said destination node is carried out using a first decryption key;
(c) said unconditional decrypting of said transmitted message by said forwarding node is carried out using a second decryption key; and
(d) said unconditional re-encrypting of said decrypted message by said forwarding node is carried out using said second encryption key.

16. The method of claim 15, wherein said second encryption key is different from said first encryption key, and said second decryption key is different from said first decryption key.

17. The method of claim 15, wherein said second encryption key is the same as said first encryption key, and said second decryption key is the same as said first decryption key.

18. An encryption and decryption system for a multi-node network, comprising:
(a) at least one source node configured to encrypt messages and to transmit said encrypted messages;
(b) at least one forwarding node configured to receive and unconditionally decrypt each said encrypted message, said forwarding node configured to unconditionally re-encrypt and transmit said decrypted messages; and
(c) at least one destination node configured to receive and decrypt said re-encrypted messages.

19. An encryption and decryption system for a multiple node network, comprising at least one forwarding node, said forwarding node including means for unconditionally decrypting all received messages, and means for unconditionally encrypting all transmitted messages.

20. The encryption and decryption system of claim 19, further comprising at least one source node, said source node including means for encrypting messages and transmitting said encrypted messages to said forwarding node.

21. The encryption and decryption system of claim 20, further comprising at least one destination node, said destination node including means for decrypting messages transmitted by said forwarding node.

22. The encryption and decryption system of claim 21, wherein said means for encrypting messages by said source node, said means for decrypting messages in said destination node, said means for unconditionally decrypting messages by said forwarding node, and said means for unconditionally encrypting messages by said forwarding node comprises symmetrical encryption and decryption.

23. The encryption and decryption system of claim 21, wherein said means for encrypting messages by said source node, said means for decrypting messages in said destination node, said means for unconditionally decrypting messages by said forwarding node, and said means for unconditionally encrypting messages by said forwarding node comprises asymmetrical encryption and decryption.
